(19) United States
(12) Patent Application Publication
(10) Pub. No.: US 2015/0221052 A1
(43) Pub. Date: Aug. 6, 2015

(54) AUTOMATED LEGAL ISSUE SPOTTING AND REASONING METHOD

(71) Applicant: John Howard Messing, Tucson, AZ (US)

(72) Inventor: John Howard Messing, Tucson, AZ (US)

(21) Appl. No.: 14/171,806

(22) Filed: Feb. 4, 2014

(51) Int. Cl. G06Q 50/18; G06N 99/00; G06N 5/04

(52) U.S. Cl. CPC G06Q 50/18; G06N 5/04; G06N 99/005

(57) ABSTRACT

A method and system for providing automated legal issue spotting and reasoning based upon a graphic user interface that queries users about operative facts defined by the application of legal principles, laws and regulations to situations to which they were intended to apply, and linking the responses as variables through rule based programming to messages for display to the user about the resolution of the particular circumstances of the case.

### CROSS REFERENCES TO RELATED APPLICATIONS

This is a continuation-in-part application of application Ser. No. 13/267,830, “Automated Legal Services Method”, filed Oct. 6, 2011 and it seeks priority dates for the claims common with that application and pre-AIA status of said application.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### BACKGROUND

1. Field of Invention

This invention describes a process with computerized software to provide legal issue spotting and reasoning based upon a method of identifying operative facts through a graphic user interface and providing context appropriate messages through rule based programming.

Operative facts describe a relationship between rules and one or a plurality of factual situations they are intended to include. For example, hypothetically, whether a patent amendment was entered during prosecution of an issued patent is an operative fact that could be important in determining the claims that were actually granted.

Specific facts that might be relevant could be whether the amendment in question was made in response to a non-final office action or after final, whether an appeal was taken or RCE filed, and whether otherwise the examiner voluntarily entered the amendments on his or her own. The specific facts applicable to the particular application in question could be plugged into the operative facts, and according to the rules of the PTO, a legally sufficient answer could be determined.

This invention describes an automated method to automate the process described in paras. 4 and 5 above, regardless of any particular area of law.

To achieve this goal, the universe of permutations and combinations of all facts of all rules, regulations, decisions and statutes under consideration is mapped to a user interface that queries for specific combinations applicable to one or a plurality of combinations of operative facts, which can optionally be pruned to what is commonly observed in legal practice for routine matters.

The graphic user interface is limited to prompts for operative facts from case specific data which the user supplies. Each such datum collected from the user is a variable for further processing.

Context appropriate messages are linked by rule based programming to specific combinations of operative facts reported as variables by the user through the interface.

Each one or a plurality of combinations is linked to appropriate communications to display according to the one or plurality of operative facts present as variables, in accordance with the laws, rules, regulations and case decisions of the specific legal content area.

Prior art in automated legal issue spotting and reasoning using operative facts mapped to a graphic user interface is apparently non-existent. One branch of prior art for legal matters describes the automatic insertion of data, collected by a computer from a user, at appropriate places in governmental furnished forms. This art therefore is limited to clerical type of tasks, unlike this invention which deals with legal issue spotting and reasoning based upon a method of identifying operative facts through a graphic user interface and providing context appropriate messages through rule based programming in response to user supplied data.

In Anglo-American law, legal reasoning is both inductive and deductive. Issues are initially spotted by identifying operative facts with their associated laws, regulations and decisions. The applicable rules from these sources are then applied deductively to reach a legal result through legal reasoning. Legal advice may be defined as the sifting through of the range of operative facts in a given real-life situation and the applicable legal rules, and then applying the rules to reach a result appropriate to the real life situation, sometimes couched in terms of percentages of likelihood, based often on more than one stated assumption.

Automating this process through programming methods of computers has not yielded satisfactory results using rule-based programming in prior art. Application of language categories to stored facts themselves has been tried and failed. Stevens, et al., “The Next Generation of Legal Expert Systems-New Dawn or False Dawn?” posited that rule based programming could not successfully be used alone for case analysis purposes and therefore recommended alternatives to it. Stevens et al. announced: “This paper explores the advantages of exploiting three alternative approaches—namely: case-based reasoning, blackboard architecture, and service-oriented architecture for the next generation of legal expert systems. The authors advocate the use of hybrid architecture to address the complexity and dynamic nature of the legal domain. The paper evaluates the extent to which these enhancements can meet the special complexities of the legal domain.”

What both these and other prior art examples have failed to grasp is that computerized legal issue spotting and reasoning includes defining operative facts based on real world facts and applicable rules to them, querying users through an interface about the particulars of a case in relation to the operate facts, and displaying context appropriate messages based on commonly occurring patterns of variable values as observed by practitioners in a legal domain area. Users interact through an interface that prompts responses for use as variables. Upon submission, messages are conveyed that provide the most context appropriate legal responses to the variables and combinations of variable values selected for and presented.

Prior art has instead relied on organization of the legal rules themselves, and their particular grammatical structures and syntax, (e.g., Stevens et al., sections 16 to 20 Sale of Goods Act (SGA), which fails to appreciate the human contribution.

Human professionals combine a knowledge of the law, the fact situations it is intended to encompass, and observed results and patterns, applying them as variables to scenarios and then advising on the likely outcomes. Mimicking that process without the high level machine self-learning methods of artificial intelligence is a difficult task but an achievable and useful one. It requires a previously unidentified step of identifying operative facts as intended by the legal rules, a graphic user interface that prompts for specifics which are returned as variables and mapping their values to messages that reflect a resolution of the matter based on the experience of professionals as captured in the method, rather than on the language and construction of the rules themselves.

Using rule based programming to implement this methodology in computer programming is a solution to a previously identified (by Stevens) impossibility in prior art. This invention delivers a series of preprogrammed messages, proposed actions or recommended strategies specific to a number of use cases, which are derived from the commonly encountered factual situation in practice. These are mapped to a graphic user interface. Inputs to the graphic user interface are designed to elicit user supplied data concerning the operative facts in each instance. The likely combinations is expressed as a universe of such responses and combinations by users, which can be culled for practical use cases. Each such likely potential combination is vetted by designers for conclusions couched as messages that describe the appropriate outcome of each such legal reasoning combination of reported operative fact reported as variables or collections of variables. Included inputs of the interface are then paired with the messages for display to the users. The graphic user interface thus prompts for user input of operative facts that apply to the commonly encountered situation. Messages are retrieved and displayed for the benefit of the human users which contain the fruits of legal issue spotting and reasoning as applied to the inputs of the operative facts that the user supplied. Through identified operative facts, messages appropriate to the interface input are displayed in a way that automates legal issue spotting and reasoning.

The net result is a delivery system for legal advice applicable to commonly encountered situations through automated means, which is a distinguishing feature of this invention over any prior art. When used by legal professionals, this invention can provide not only a reminder of a wide range of criteria to be applied in commonly occurring factual circumstances that can otherwise be easily overlooked or forgotten by human professionals, but also in more complex and less frequently encountered situations, it can separate out issues requiring more refined legal analysis by siphoning off and resolving through automated means the more commonly encountered ones. When used by laypeople, it can in many commonly encountered situations provide an economical, simplified alternative to traditional human legal services. Inasmuch as pro se representation in many legal matters is increasing significantly because professional legal representation is becoming priced out of the reach of general public, such automated means offer increased efficiency and reduced costs in the delivery of legal services by providing legal information and advice for routine matters by computer and reserving human legal talent to those instances where it is most effective.

This invention differs from artificial intelligence in that there is no requirement for a computer to learn human legal tasks through trial and error in order to achieve a professional level of proficiency, which can be an extremely costly and time-consuming process.

An example of prior art using artificial intelligence is Visel, et al. U.S. Pat. No. 8,001,067, “Method for substituting an electronic emulation of the human brain into an application to replace a human” that requires sophisticated computer programming coupled with arduous learning of the computer from a controlled environment to reach programming goals. A goal of that method is to equip a computer to make decisions when confronted with facts outside the experience of it or its programmers, which intentionally is not also a goal of this invention, because of time, resource, and expense considerations. The infrastructure and human effort to teach skilled legal analysis to a computer using such a method can be staggering. The simpler and relatively inexpensive methods of this invention can achieve useful results at a fraction of the cost and time.

A different type of prior art for automated legal services is taught by Meltzer, et al., U.S. Pat. No. 7,558,782, “Network based legal services system”, which provides an interactive form to conclude a contract of representation online between a client and an attorney, and a secure channel of communication and reserved data store for each client where attorney-client communications regarding legal matters can be accessed and archived online. The example of prior art facilitates confidential attorney client communications securely over the Internet without requiring personal interaction as in an office setting, thus logistically saving time and travel, but it does not also include a component to automate legal issue spotting and reasoning based upon a method of identifying operative facts through a graphic user interface and providing context appropriate messages through rule based programming.

There are also a number of examples of prior art use of computers to perform clerical form selection and filling out tasks which are related to legal processes or benefits, which include Salzmann, U.S. Pat. No. 7,742,991, “Method & system for managing and preparing documentation for real estate transactions” (forms selection for real estate transactions) and Zilberfayn, United States Patent Application Publication No. 20090182717, “Interactive Forms Processing System and Method” (forms selection and filling out by self represented litigants in court proceedings).

Another example of this type of form-related prior art is Petrucelli, United States Patent Application Publication No. 20090313200, “Immigration application management apparatus, systems, and methods”, which claims a method for assisting a non-lawyer user in filling out official forms to be submitted for immigration benefits. It postulates generally a “wizard” (without also specifying precisely how such a wizard functions for the benefit of one skilled in the art) to interactively prompt users for answers that will be acceptable to government decision makers, described as follows: “The wizard may in certain instances offer a selection of appropriate answers and assist the applicant in determining which response is appropriate. For example, if a government form asks the applicant if he has ever been convicted of a crime, the wizard will may [sic] indicate to the user what constitutes a crime in the context of that form. If, for instance a driving violation constitutes a crime for a particular application, the wizard will assist the user in answering the form correctly. The wizard may in certain instances offer additional or clarifying questions not asked on the form. The wizard also may screen user information to sift through what is relevant to the form filling in process. If a user of the system 200 would like additional professional guidance regarding an application processed through the system 200, the system 200 may provide referral to, by way of non-limiting example, specialized immigration law counsel.” (Id. at para 0030).

The prior art examples of filling out forms do not describe or anticipate this invention. As to all three cited examples, they have, as an objective, computer-assisted filling out of forms for specific legally-related benefits, and not legal issue spotting and reasoning based upon a method of identifying operative facts through a graphic user interface and providing context appropriate messages through rule based programming, as does this invention. The first two prior art examples relate to selecting and completing the proper forms to fill out. The last example, Petrucelli, also teaches the provision of automated prompts to elicit correct responses from users in completing immigration forms. The present invention differs considerably from the prior art of form filling by providing automated legal information or advice to users for factual situations that are foreseeable as routinely encountered and that can be accommodated by relatively straightforward advice or information. Such advice or information can be made available regardless of whether completed legal forms to obtain benefits may also be required, or a specific subject matter area of law may be involved (such as immigration, real estate, or divorce litigation). The present invention also provides programmed branching logic as a basis to refer a suitable legal matter to a human legal adviser as an alternative or supplement to the automated system, in contrast to Petrucelli, supra, which simply mentions availability of skilled counsel as an option for users who on their own feel a need to seek it, without program prompting. The present invention therefore is an advance over prior form-filling art, even with a hypothetical “wizard” designed to assist in arriving at acceptable answers to immigration form questions.

The prior art limitations are overcome by the present invention, as described in that which follows.

3. Objects and Advantages

A primary object of the present invention is to enable legal issue spotting and reasoning based upon a method of identifying operative facts through a graphic user, querying for case specific input retrieved as variables through the interface and providing context appropriate messages through rule based programming based on the variables retrieved.

Another object of the present invention is to enable an automated legal issue spotting and reasoning method to permit the provision of legal information or advice by computer for commonly encountered situations in practice.

Another object of the present invention is to avoid reliance solely upon automated legal issue spotting and reasoning in situations where it is inappropriate and where human intervention by a qualified professional is required. In such cases, the invention determines through programmed parameters from the user input that a referral of the user to a human professional for further such legal advice is appropriate or required. A dividing line between situations appropriate for automated delivery or human legal consultation, or a mixture of them, and the implementation of these distinctions, is one advantage of this invention.

Another object of the present invention is to provide a server based automated legal issue spotting and reasoning method that allows multiple users to obtain automated legal information or advice over the Internet from a computer server or cloud.

Another object of this invention is to enable the automated provision of legal services by standalone computer applications or downloaded apps in addition to networked client server-server relationships.

Another object of the present invention is to provide a server based automated legal issue spotting and reasoning method that obtains inputs from web servers and web services in addition to individuals using web browsers and that transmits results to web servers and as web services, by peer file sharing, ftp, soap or http and equivalent methods, in addition to transmissions to individuals via web browser, mobile phone, iPad, or other client/server handheld or mobile devices.

Other objects and advantages of the present invention will become obvious to the reader and it is intended that these objects and advantages be acknowledged as within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated, and that the full scope of the invention should be determined by the allowed claims and not the described specification.

### SUMMARY OF THE INVENTION

The present specification describes an automated legal issue spotting and legal reasoning method to analyze by automated means that can apply to many legal domains and specifically describes two examples drawn from U.S. immigration law. In the first preferred embodiment, a petitioner or substitute or joint sponsor must demonstrate an ability to support a foreign relative who is in the process of applying for permanent residency. The support requirement is set forth and described in statutes, regulations, and official instructions, and makes use of Poverty Guidelines of the United States Government. Successfully qualifying for the support requirement can be one of the more onerous tasks practically for a U.S. citizen who is applying for permanent residency on behalf of an immediate family member. Basic prerequisites can be determined using automated legal analysis, with referrals being made to human professionals where more sophisticated legal analysis is also or alternatively required. Such a support analysis should be undertaken early in an immigration case, before official forms are even referenced, to see if a person can qualify on the basis his or own earning power, in light of household size, or a joint sponsor or other method of meeting the support criteria will be required.

In a second preferred embodiment, a computer interface in Spanish and English queries prospective applicants for Deferred Action for Childhood Arrivals (DACA) about operative facts pertinent to an application for a young person brought to the U.S. illegally as a child in order to remain in the country and not be deported. Depending on the input, context appropriate messages about eligibility are displayed with an overall score (1,2 or 3) that indicate the likelihood success of an application under the circumstances described by the user through the interface. The actual combination of inputs in a particular query session is mapped to legal issue spotting and reasoning functions built into the program that call forth pre-configured messages to report to the user through rule based programming about user eligibility for the program based on the inputs as variables retrieved from the user through the interface.

The invention as operational requires a personal computer with AMD Turion 64 processor and 2 GB of memory, a 32-bit Windows XP operating system with a Windows Server Internet Information Server 5.1 (IIS), Adobe Cold Fusion 9.01 (CF), and Mozilla Firefox 6.02 (FF). The application uses the CF middleware to query a user and display results through the FF browser, utilizing FF plug-ins as appropriate. A computer monitor is required to view the input interface and display results, and a keyboard and mouse to make selections and enter data.

In the first preferred embodiment, a user is presented with a graphic user interface that elicits case specific facts concerning the financial earning power of a sponsor and the size of the sponsor's household, both of which can be extremely important legally in determining the qualification of an individual to qualify as a sponsor for the support obligation (i.e., they are operative facts). Other operative facts include the geographic area where the sponsor lives, whether the sponsor is on active military duty in the armed forces of the United States, the sponsor's relationship to the person or persons being sponsored, the number of persons to be sponsored, the sponsor's age and immigration status and the existence and the number of other household members willing to share or contribute to support requirements, which are also referenced for selections or inputs in the graphic user interface. A display of the plurality of appropriate inputs with default selections appears in FIG. 1.

The user makes his or her selections and inputs to the graphic user interface according to the facts as they exist in the user's case and submits them to a server. Examples of certain selections, displayed as hypothetical queries, are shown in FIGS. 2, 4 and 6.

Depending on the combination of selections, and the applicable rules, regulations and norms to be referenced, the server either reports that the sponsor meets the legal requirements, or alternatively, if the sponsor does not meet them, the reason for such disqualification, and in such case, possible options and strategies to overcome a disqualification in accordance with legal rules associated with the plurality of inputs selected by the user. Examples of such responses appear in FIGS. 3, 5 and 7, and correspond respectively to the inputs in FIGS. 2, 4 and 6. As part of the automated legal issue spotting and reasoning, the user can be told to consult a human professional for further follow-up as appropriate, as a supplement to the automated analysis. Examples appear in FIGS. 5 and 7.

The present invention as exemplified but not limited by the first and second preferred embodiments satisfies a need in the marketplace for economical delivery of legal services in routine matters that can be handled without, or with a minimum of, human intervention through automated legal issue spotting and reasoning.

Following the same line of reasoning, the invention helps to focus the legal efforts of human professionals and direct them to more sophisticated challenges while automatically handling more routine aspects, which can otherwise be distracting to the human professional, and which with this invention can be suitably automated by computerized means.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining in detail the two preferred embodiments of the invention, with explanations of others as relevant, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS—FIGS. 1-15

Various other objects, features and attendant advantages of the present invention will become fully appreciated as the same become better understood when considered in conjunction with the accompanying drawings, in which by means of like reference characters designate the same or similar parts throughout the several views, and wherein:

FIG. 1 depicts the graphic user interface of the first preferred embodiment of this invention before selections have been made by a user, with the plurality of selections and text inputs in default mode. The CAPTCHA security feature has been deliberately omitted as irrelevant to the present invention, as no claims are made concerning it. There is a form submission button that submits the inputs selected by the user to the server, and associated text relating to terms and conditions of use. Except for FIG. 1, the form submission button and associated text is consistently omitted as superfluous to teaching this invention to one skilled in the art, and should be assumed in all other FIGs where it would otherwise appear.

FIG. 2 depicts selections pertaining to a hypothetical individual who is seeking permanent residency in the United States for a family member. Certain inputs have been selected by a hypothetical user pertaining to parameters that will enable a return of automated legal information or advice.

FIG. 3 depicts the results returned to the user as human readable text from the inputs of FIG. 2 and in light of the applicable legal rules referenced.

FIG. 4 depicts additional selections pertaining to the same hypothetical individual as in FIG. 2-3. Certain additional inputs have been selected by the user pertaining to parameters that reference legal rules and regulations, which additional selections cause a different returned information or advice from that in FIG. 2-3.

FIG. 5 depicts the results returned to the user as human readable text from the inputs of FIG. 4 and in light of the applicable legal rules referenced.

FIG. 6 depicts certain other selections pertaining to the same hypothetical individual as in FIG. 2 and FIG. 4. Such other additional inputs have also been selected by the user pertaining to parameters that reference legal rules and regulations, which change the returned information or advice from that both in FIG. 2-3 and FIG. 4-5.

FIG. 7 depicts the results returned to the user as human readable text from the inputs of FIG. 6 and in light of the applicable legal rules referenced.

FIG. 8 and FIG. 9 depict as a flow chart the method as it applies generally. Operative facts as the intended scope of laws, regulations, decisions and rules are identified. A user interface is constructed to query a user about case specific information relative to the operative facts. The results as variables or collections of variables are mapped to context appropriate messages to display to the user.

FIGS. 10 through 15 show how the method is developed with respect to deferred action for childhood arrivals, which is a form of immigration benefit implemented through federal executive action.

### DESCRIPTION OF THE FIRST PREFERRED EMBODIMENT

To achieve the previously-identified objectives, the present inventive device utilizes an independent central processing unit which may be standalone or alternatively interfaces with one or a plurality of users to provide automated legal issue spotting and legal reasoning pertaining to selected factual scenarios that arise routinely in legal practice and it may employ one or a plurality of tools such as a queue in an Internet server context to improve server performance.

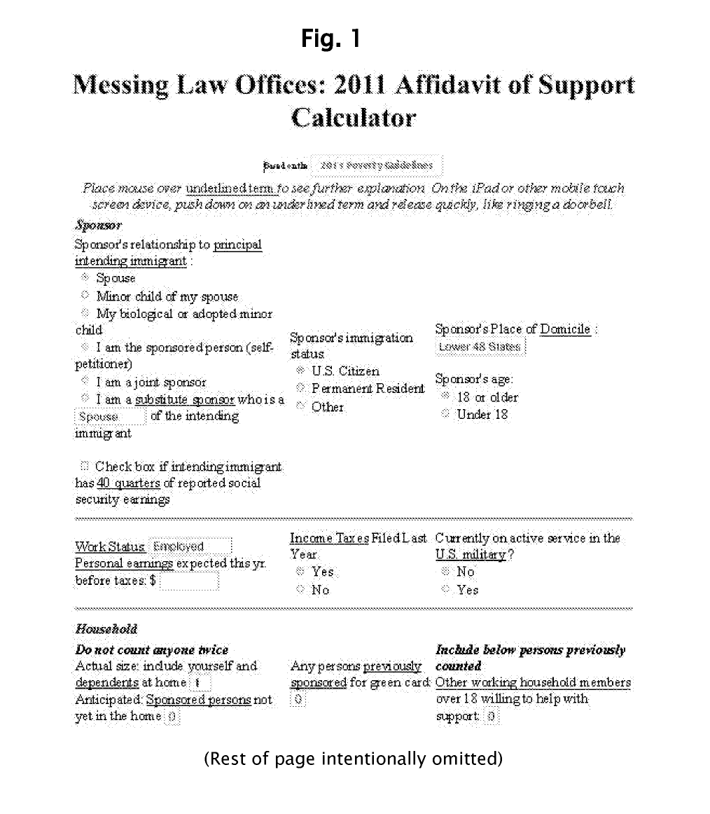

### First Preferred Embodiment Description—FIGS. 1-7

FIG. 1 depicts the graphic user interface of the invention before selections have been made by a user, with the plurality of selections and text inputs in default mode that are presented to the user and designed to collect information pertaining to a specific subject for which legal information or advice is sought.

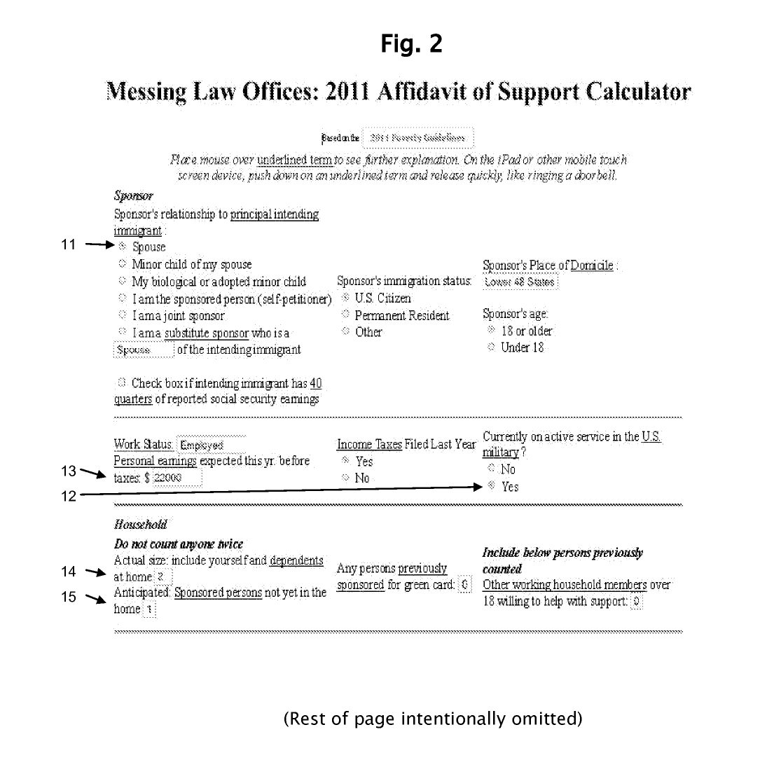

FIG. 2 depicts selections pertaining to a hypothetical individual who is seeking permanent residency in the United States for a family member. The selections show that the user is on active military service in the U.S. armed forces, earns $22,000 per year, is a U.S. citizen over the age of 18, and resides in one of the lower 48 states. There are two dependents in the household of the user, including the user, and one relative who is being sponsored who has not yet joined the household. There is no other working member of the household who can or is willing to contribute to the support obligation, and no prior support obligation to anyone else from the user.

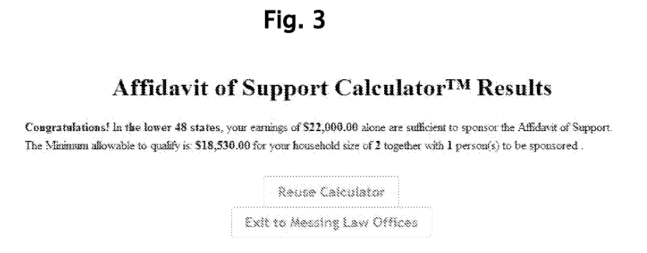

FIG. 3 depicts the results returned to the user as human readable text from the inputs of FIG. 2 and in light of the applicable legal rules referenced. The user qualifies under the legal rules and regulations as eligible to legally undertake a support obligation with these inputs for a foreign relative's petition for permanent residency.

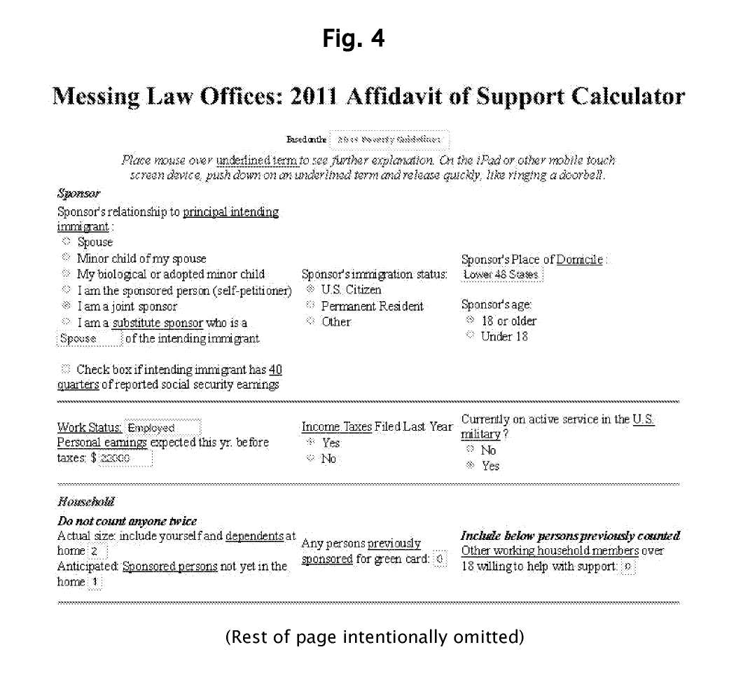

FIG. 4 depicts a slightly different set of selections and text inputs of the hypothetical user. Like the user depicted in FIG. 2, the user is on active military service, earns $22,000 per year, is a U.S. citizen over the age of 18, and resides in one of the lower 48 states. Unlike the user in FIG. 2, this user is being considered for the role of a joint sponsor instead of the principal sponsor, which means he or she is assuming secondary responsibility for the support requirement, usually because the principal sponsor fails to qualify alone, and a joint sponsor is needed to help meet the requirements. The change in relationship to the person being sponsored is the only difference between the examples.

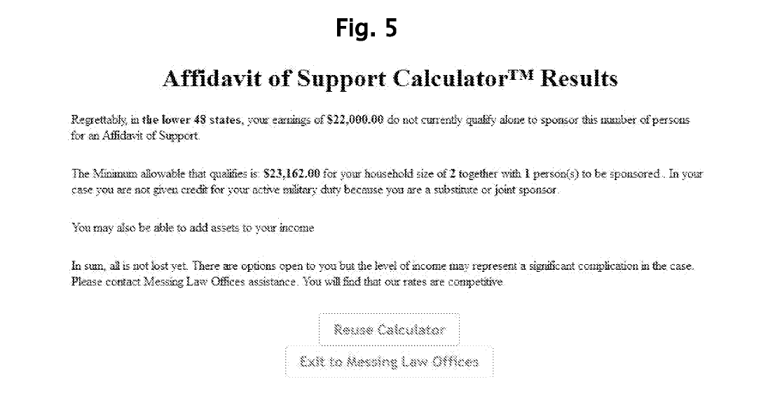

FIG. 5 depicts the results returned to the user as human readable text from the inputs of FIG. 4 and in light of the applicable legal rules referenced. Unlike the user in FIG. 2-3, the user in FIG. 4-5 fails to qualify under the legal rules and regulations as a joint sponsor. That is because under applicable legal rules a joint sponsor does not benefit from the same favorable treatment accorded to members of the military on active duty as primary sponsors, but instead under the applicable rules is treated the same as non-military sponsors. With less favorable treatment, the joint sponsor fails to qualify. Other possible strategies are suggested by the computer display, as set forth in FIG. 5. A referral to available legal counsel is also made for additional help.

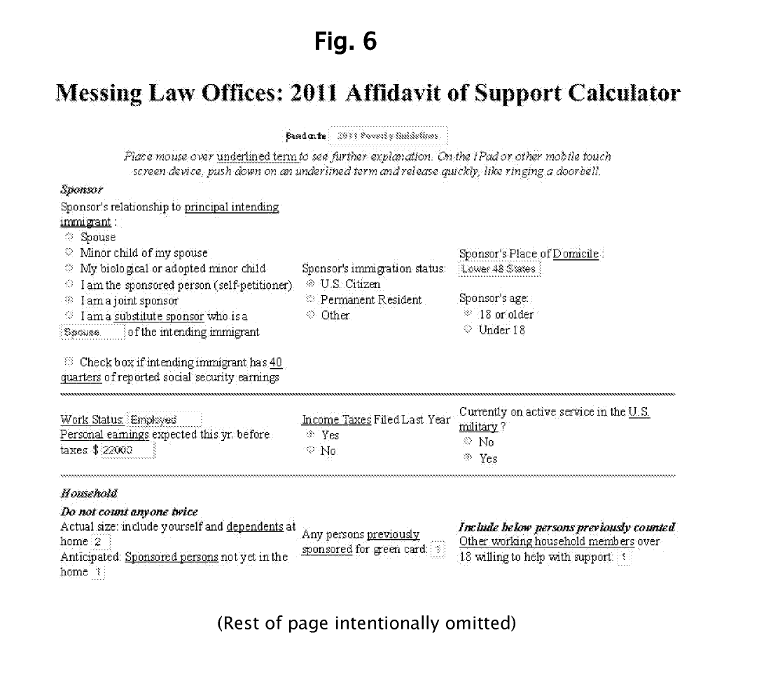

FIG. 6 depicts a slightly different set of selections and text inputs of a hypothetical user. Like the user depicted in FIG. 2 and FIG. 4, the user is on active military service, earns $22,000 per year, is a U.S. citizen over the age of 18, and resides in one of the lower 48 states. Like the user in FIG. 4 and unlike the user in FIG. 2, this user proposes to be a joint sponsor instead of a principal sponsor. Unlike the users in either FIG. 4 or FIG. 2, the user in FIG. 6 both has a member of the household who is willing and able to contribute to the support obligation of the joint sponsor, and the joint sponsor has already sponsored another successful applicant for permanent residency in the past.

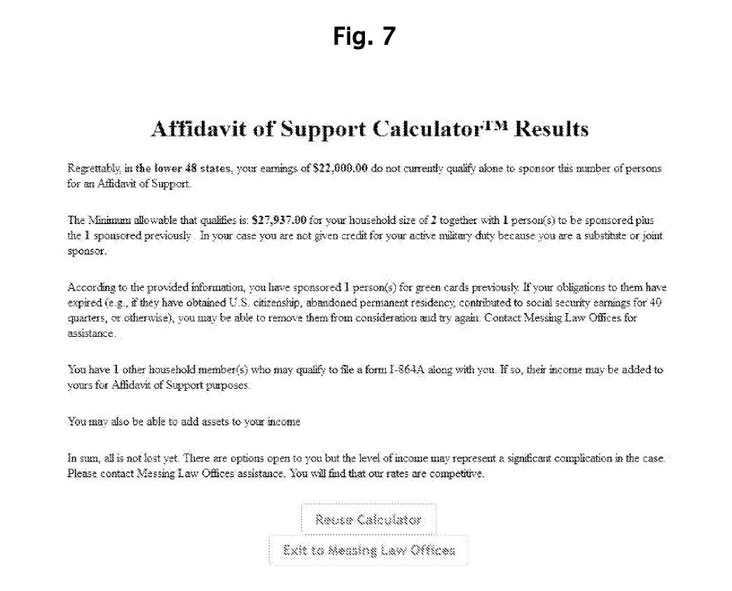

FIG. 7 depicts the results returned to the user as human readable text from the inputs of FIG. 6 and in light of the applicable legal rules referenced. Like the user in FIG. 4-5 and for the same reasons, and unlike the user in FIG. 2-3, the user in FIG. 6-7 fails to qualify under the legal rules and regulations as a joint sponsor. Some of the possible strategies set forth in FIG. 5 are shown again in FIG. 7, along with two others that refer to the existence of the willing household member and the prior sponsorship of a permanent resident application in the past. A referral to available legal counsel is also made for additional help.

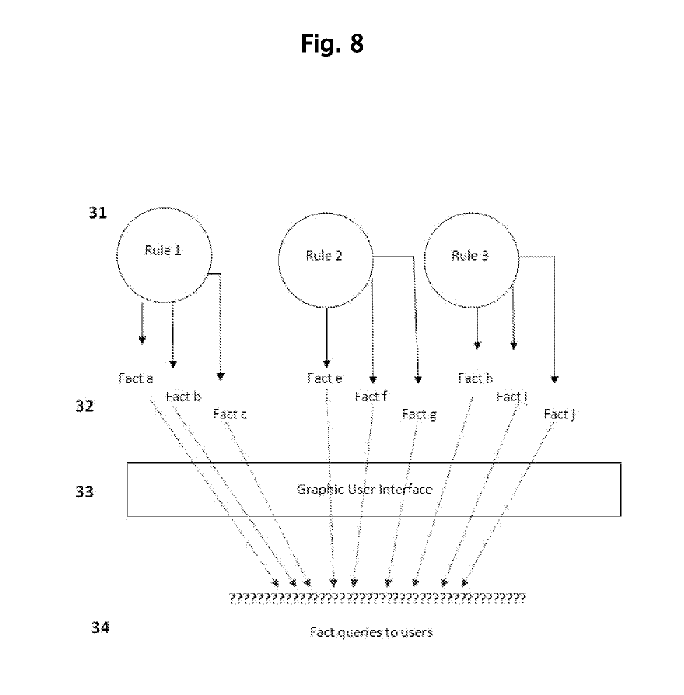

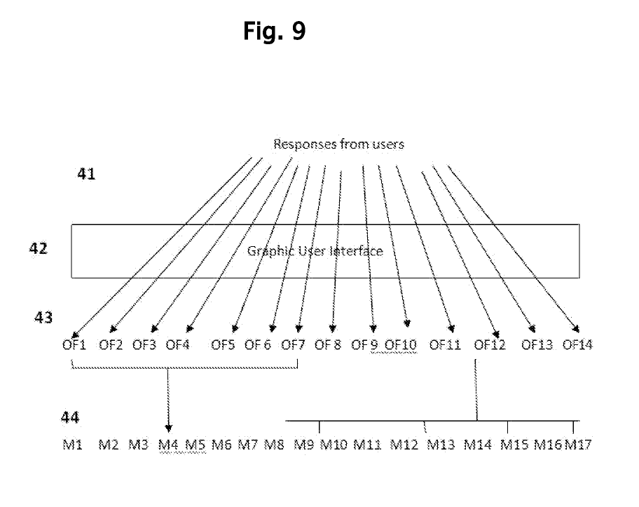

### Description of Method—FIGS. 8-9

FIG. 8 and FIG. 9 illustrate the concept of this invention graphically. A collection of rules, FIG. 8, no. 31 applicable to the legal domain area are identified with likely fact scenarios that will yield operative facts, no. 32. These are structured into the graphic user interface no. 33 as fact queries to users regarding case specific information relevant to the operative facts.

FIG. 9 illustrates the processing of the responses no. 41 received back from the users. They are processed with regard to the operative facts to which they relate no. 43 and through rule based programming the responses bring up messages no. 44 appropriate to the factual context revealed by the response. Thus, with regard to no. 44, a response that includes both OF1 and OF7 variables triggers M4, a message suitable to that pair. Similarly, though in a converse manner, an OF1 2 variable triggers messages M10, M13, M15 and M17 for display to the user.

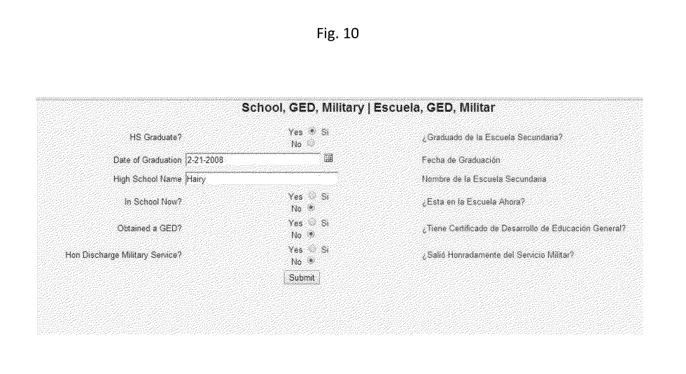

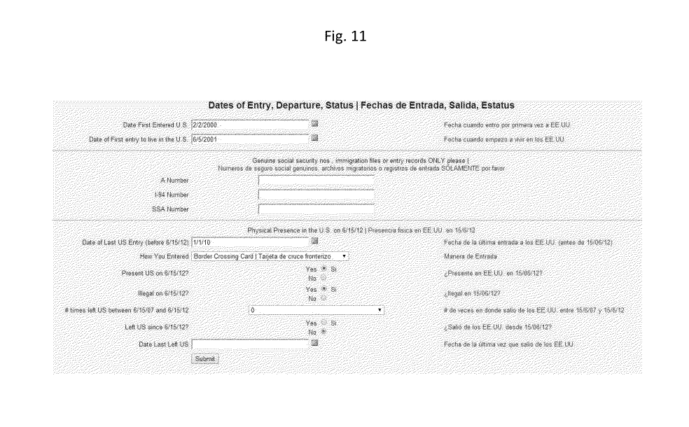

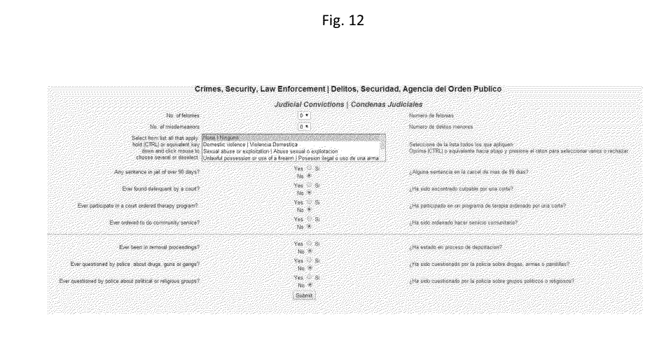

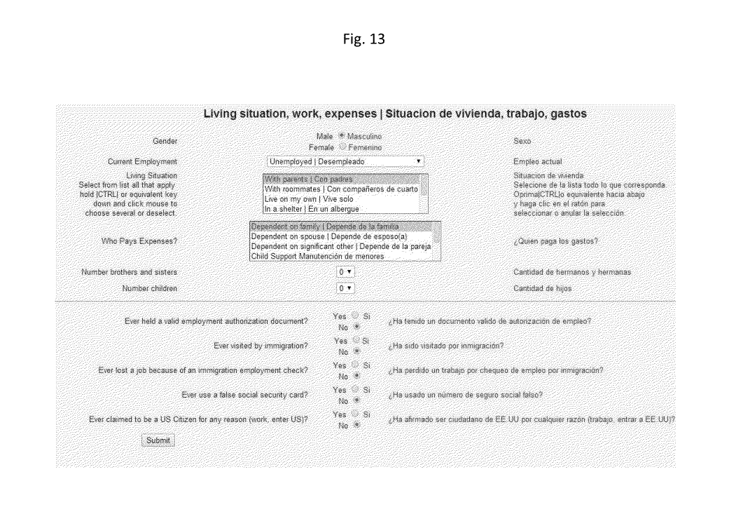

### Second Preferred Embodiment Description—FIGS. 10-15

In a second preferred embodiment, an applicant for deferred action for childhood arrivals is queried through the user interface about the various operative facts relating to first arrival in the US, departures from the US, entries back into the US, education, age, employment and law enforcement history to determine if under the regulations of the Department of Homeland Security deferred action and employment authorization can be obtained.

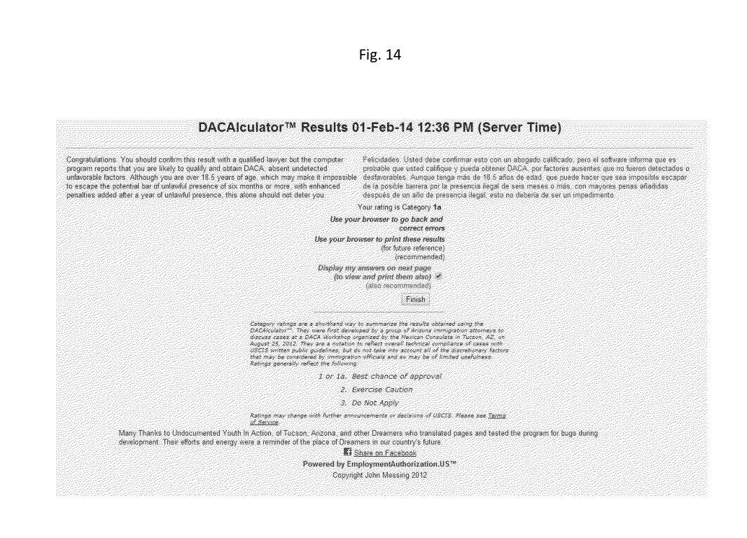

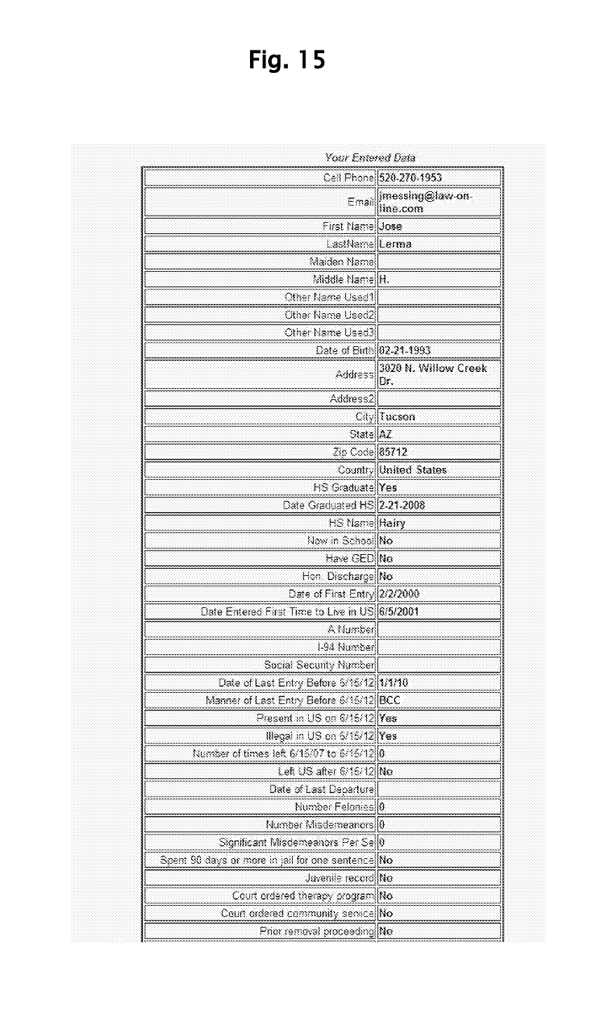

FIGS. 10-15 display various iterations of the graphic user interface designed to query the user about the specific circumstances of a deferred action application that correspond to the operative facts. FIG. 14 displays a message that is responsive to the operative fact information provided by the user. FIG. 15 summarizes the variable inputs from the user for the benefit of a professional or para-professional for analysis and action.

As one skilled in the art will appreciate, a user interface includes inputs to be completed by keyboard, smartphone, handheld device (ipad or ipad like), mouse, touchscreen, stylus or voice activation. Such user interface also enables a human to electronically trigger an action by clicking a mouse, touching a screen, pointing a finger or displaying other body part to a device, entering one or a plurality of characters by keyboard, touchscreen, or dictation, moving a finger or stylus across a pad or screen, or word commands.

A computer structurally effectuates all actions and storage of the information generated by the invention and its related processes, systems, and methods. The computer receives the electronic requests for information or advice, and disseminates the returned results via machine-to-machine transfers or alternatively via email, text messaging, or telefax. It functions to store various possible input parameters corresponding to the various recurring factual situations and associates responses that have been fashioned from the application of rules, regulations and norms to them. When queried by user inputs that are submitted to it, the server invokes the programmed branching logic and returns the various displayed messages containing the legal information or advice, coupled as appropriate with a referral to a human legal adviser for additional or alternatively, solely human-provided legal information or advice.

The computer may be connected to other computers, may arise in a server-client setting or wholly standalone application. Interconnections between computers include any and all networks and or systems or applications that facilitate the sending and receipt of legal information or advice or referrals, if any, and any and all infrastructure necessary. The various processing systems may also include multiple and various types of computers, such as a mainframe computer which may be preferably coupled to a Wide Area, Local Area Network or Internet by means of communications link. Those skilled in the art will appreciate that any such computer may be located a great geographic distance from the WAN or LAN or an Internet server computer.

With respect to the above description then, it is deemed readily apparent and obvious to one skilled in the art, that all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### CONCLUSIONS, RAMIFICATIONS AND SCOPE

Accordingly, it can be seen that the above system allows a computer to legal issue spot and reason based upon a graphic user interface programmed to identify operative facts which are those intended to be governed by a set of rules, regulations, laws and decisions, to query users through the user interface, and to receive the responses as parameters which are linked to context appropriate messages to resolve routine legal matters or indicate the parameters which should be considered.

Although the description above contains much specificity, this should not be construed as limiting the scope of the invention but as merely providing illustrations of some of the presently preferred embodiments of this invention.

Thus the scope of the invention should be determined by the appended claims and their legal equivalents, rather than by the description and examples given.

What is claimed is:

1-20. (canceled)

21. A method for automated legal issue spotting and reasoning, with
a graphical user interface having:
one or a plurality of inputs that correspond to one or a plurality of legally operative facts;
one or a plurality of selections for such inputs to elicit circumstances or conditions pertaining to a user in relation to such legally operative facts;
upon submission of the user's selections, one or a plurality of messages pertaining to the one or a plurality of legally operative facts are retrieved according to the user's selections;
an output is generated of such retrieved messages,
whereby pertinent legal information or advice is determined by computerized means other than an expert system incorporating data storage devices with self-learning capability utilizing machine-learning techniques.

22. The method of claim 21 whereby one or a plurality of variables are instantiated from such one or a plurality of selections to determine the one or a plurality of messages to be retrieved.

23. The method of claim 21 whereby the one or a plurality of retrieved messages includes optionally the rules, regulations and decisions applicable to one or a plurality of governing legally operative facts, a legal analysis, a conclusion, a brief, an agreement, or a recommendation.

24. The method of claim 21 whereby such messages are conveyed to the user in human understandable form through the graphical user interface.

25. The method of claim 22 whereby such messages include text.

26. The method of claim 22 whereby such messages include audio and/or video.

27. The method of claim 22 whereby such messages are conveyed in machine readable form.

28. The method of claim 21 whereby a mouse, touch screen, voice command, mark-up language, storage or memory device, keyboard, keypad, stylus, biometric identifier, or cryptographical cipher is used to make the one or plurality of selections afforded by the graphical user interface.

29. An apparatus for automated legal issue spotting and reasoning, comprising a computer and having:
at least one central processing unit;
a memory;
a storage device;
optionally, a network connection;
optionally, a display;
optionally, an input device;
optionally, at least one database;
a graphical user interface having:
one or a plurality of inputs that correspond to one or a plurality of legally operative facts;
one or a plurality of selections for such inputs that describe circumstances or conditions pertaining a user;
optionally, one or a plurality of variables which are instantiated by the one or a plurality of inputs according to the values of the inputs submitted by a user;
one or a plurality of messages pertaining to the one or a plurality of legally operative facts for retrieval according to the one or a plurality of selections of the user;
an output for such retrieved messages,
whereby legal information or advice pertaining to a user is determined by computerized apparatus other than an expert system incorporating data storage devices with self-learning capability utilizing machine-learning techniques.

30. The apparatus of claim 29 whereby an input device comprises one or a plurality of a mouse, touch screen, voice command, mark-up language, storage or memory device, keyboard, keypad, stylus, biometric identifier, or cryptographical cipher.

31. The apparatus of claim 29 whereby the one or a plurality of retrieved messages includes optionally the rules, regulations and decisions applicable to one or a plurality of governing legally operative facts, a legal analysis, a conclusion, a brief, an agreement, or a recommendation.

32. A method for automated legal issue spotting and reasoning, comprising
one or a plurality of selections of a graphical user interface that describe one or a plurality of specific circumstances or conditions of a user pertaining to one or a plurality of legally operative facts;
upon submission of the user's selections, retrieval of one or a plurality of messages pertaining to one or a plurality of legally operative facts according to such user selections;
an output of such retrieved messages,
whereby legal information or advice is determined by computerized means other than an expert system incorporating data storage devices with self-learning capability utilizing machine-learning techniques.

33. The method of claim 32 whereby a mouse, touch screen, voice command, mark-up language, storage or memory device, keyboard, keypad, stylus, biometric identifier, or cryptographic cipher is used to signify a user's selections.

34. The method of claim 32 whereby the one or a plurality of retrieved messages includes optionally the rules, regulations and decisions applicable to the legally operative facts, a legal analysis, a conclusion, a brief, an agreement, or a recommendation.

35. The method of claim 32 whereby one or a plurality of variables are instantiated from such one or a plurality of selections to determine the one or a plurality of collections of one or a plurality of messages to be retrieved.

36. The method of claim 32 whereby such retrieved messages are transmitted via a network.

37. The method of claim 36 whereby such network includes the Internet.

38. The method of claim 32 whereby such retrieved messages are transmitted via a mark up language.

39. The method of claim 32 whereby such retrieved messages travel via machine to machine.

40. The method of claim 37 whereby such messages are retrieved from a cloud computing server.
